(19) United States
(12) Patent Application Publication
(10) Pub. No.: US 2013/0025626 A1
(43) Pub. Date: Jan. 31, 2013

(54) POOL CLEANING APPARATUS AND RELATED METHODS

(71) Applicant: ERIC RESH, Temecula, CA (US)

(72) Inventor: ERIC RESH, Temecula, CA (US)

(21) Appl. No.: 13/193,188

(22) Filed: Jul. 28, 2011

(51) Int. Cl. E04H 4/16; F16B 1/00

(52) U.S. Cl. 134/6; 15/118; 210/470; 403/179; 24/570

(57) ABSTRACT

A tool for cleaning debris from swimming pools includes a frame, a corresponding net, and retaining means for retaining the net on the frame. The preferred retaining means is an elongated strip of resilient, flexible material, having a generally U-shaped cross-section. The web portion of the cross-section includes an exterior surface smoothly shaped between its two edges to urge debris from the pool into the net. The leg portions of the cross-section include gripping portions to assist in engaging and/or disengaging the retaining means from the frame, to permit the net to be assembled, changed or replaced. Preferably, the retaining means is formed from at least two different materials. The preferred frame of the tool is fabricated from aluminum and includes an elongated, curved frame portion with its ends permanently assembled into the end of a tubular attachment member, to permit attachment of the tool to a handle, pole or similar structure. The preferred net of the tool includes one or more anti-slip devices to prevent the edge of the net or bag from slipping between the frame portion and retaining means. A corresponding preferred method of use is also disclosed.

### FIELD OF THE INVENTION

This invention relates to devices for cleaning swimming pools and similar things, and more specifically is directed to apparatus and methods involving a cleaning tool utilizing a frame with a net retained thereon by a retaining member, and the retaining member is formed from at least two different materials.

The disclosures of my previously-issued U.S. Pat. Nos. 5,473,786, 6,302,277, and 6,368,502 are incorporated by reference as if expressly stated herein.

### BACKGROUND OF THE INVENTION

A wide variety of tools and processes have been developed to clean swimming pools and similar things (fountains, spas—both above and below ground, fish ponds, etc.), including and in addition to those described in my previously-issued U.S. Pat. Nos. 5,473,786 and 6,302,277. Among those devices and methods are devices that are commonly referred to as “leaf rakes”. Commonly, leaf rakes utilize a modular approach in order to permit replacement of parts of the leaf rake that tend to wear out. Among such prior art modular devices are some of mine (the Piranha Net PA-500 and Stingray Net SR-400), and others such as Purity Red Baron. Devices such as these typically include a replaceable net sized and configured to fit a frame, a replaceable elongated clip that serves as a retaining means to hold the net to the frame and a contact edge or lip (or cleaning surface) that makes contact with the interior surfaces of a pool. Also commonly and also modularly, an attachment means is provided to attach the frame to a handle or pole.

The Leslie's Pro Rake is another type of leaf rake that utilizes a modular approach. Its retaining means is not an elongated clip, but a very rigid, collar-like element with a net means permanently attached thereto. The collar and net means are snapped over the mouth portion of the frame during assembly. The Leslie's Pro Rake has an additional component that snaps over the front portion of the collar and on which a cleaning surface makes contact with an interior pool surface. In addition, some models of the Leslie's Pro Rake have a flexible tip on the contact portion of the additional snapping portion.

Prior art attempts to permit modular assembly and/or disassembly have many shortcomings. Among other things, the elongated clip must be stiff enough to retain the net on the frame while at the same time being flexible enough to permit ease of assembly and disassembly. Since securely retaining the net on the frame is more often a greater concern, the resulting rigidity of the elongated clip/retaining means tends to compromise the ease of assembly, disassembly, and/or replacement of parts.

Further compromise associated with rigidity occurs in the performance of the leaf rake as it is used on various surfaces found in swimming pools, spas, fountains, and other water features. In pools that have hard surfaces such as plaster, Pebble Tec, and rock, the portions of the elongated clip that make contact with such surfaces tend to last longer and perform better when they are rigid. However, in pools that have soft and smooth surfaces such as vinyl, fiberglass, acrylic, and tile, the benefits of having rigid contact portions of the elongated clip are limited. Fiberglass, acrylic and tile surfaces are generally very smooth and even slippery; sometimes these surfaces are made with varying textures that reduce slippage by giving grip to a swimmer's feet. When cleaning very smooth and slippery surfaces, the rigid contact portions of a conventional elongated retaining clip tend to glide over such surfaces almost too easily and, as a result, some debris may escape cleaning by either sliding between the clip and the smooth surface or sliding around the leaf net itself. Said another way, such rigid contact edges can prevent those contact edges from conforming very well to the surface being cleaned—the edges may not be sufficiently flexible. When cleaning surfaces that have slip reducing textures, this problem may be compounded; very small debris such as sand may easily slide between the textured surface and the contact points of a rigid elongated clip because the rigidity does not allow the contact points to conform to the variations of the textured surfaces.

Furthermore, the liners of vinyl pools, both in-ground and above ground, often lay directly upon firm surfaces such as concrete, wood, or dirt. It is not uncommon for tiny objects such as very small rocks, granules of sand, or other debris to be caught between the vinyl liner and the firm surface upon which it lays, resulting in small bumps in the liner. Though often very small, such bumps are usually detectable when struck by the contact points of a rigid elongated retaining clip during cleaning As a result, the smoothness of motion that contributes to ease of cleaning is reduced or compromised as the rigid contact points of the cleaning tool grind against the liner. Furthermore, the small rocks and debris beneath the vinyl liner are potential hazards to the integrity of the vinyl liner, especially if the liner above those rocks and debris is subject to repeated abrasion. In extreme cases, the integrity of the liner of a vinyl pool may ultimately be compromised to the point where a leak forms in the areas where heavy abrasion occurs (such as from repeated cleanings from a leaf rake).

Additionally, the contact points of elongated clips have many possible configurations, with each configuration having unique features that contribute to the effectiveness of the cleaning tool. The profiles of some elongated retaining clips are designed to actually scoop under targeted debris during cleaning by providing a smooth, ramping transition surface that urges targeted debris into the net. Such configurations are described in my U.S. Pat. No. 5,473,786. Other profiles (such as that found on the Purity Red Baron device) are limited in their ability to lift targeted debris. Whatever the configuration, the rigidity of the elongated clip remains a factor that limits effectiveness in cleaning on some surfaces, especially vinyl liners, fiberglass, acrylic, and tile for the reasons mentioned above.

On the other hand, however, these clip elements typically cannot be made from a material that is too flexible or soft, because such material may be too easily damaged and/or it may not provide the degree of stiffness and structural integrity that is sometimes needed and desired during the cleaning process (for example, to scrape accumulated debris from the bottom of a pool, or to effectively clean a large smooth area of the pool surface).

Moreover, the elongated retaining clips currently used on leaf rakes typically are made from a single plastic substance which is extruded from a single die. Plastic extrusion is a well-known manufacturing process by which molten plastic is forced through a die, the die being a steel plate with an opening shaped so that the plastic forced through that opening has a given desired profile. As the molten plastic passes through the die, it takes on the general yet enlarged shape of the opening's profile. The newly formed molten plastic is then pulled for a distance of several yards, being stretched, formed and cooled until it takes its intended shape.

These single-material retaining clips used on leaf rakes have the dilemma discussed above; they must be both rigid enough to retain a net on a frame while also being flexible enough to permit assembly, disassembly, and reassembly with replacement parts, and their contacting edges must similarly strike a balance between sufficient stiffness and sufficient flexibility. Those compromises result in similar compromises in the pool leaf rake's performance.

### OBJECTS AND ADVANTAGES OF THE INVENTION

It is, therefore, one of the many objects of my invention to provide an improved tool for cleaning debris from swimming pools, including the combination of a frame means forming a mouth portion and a net means covering the mouth portion, with an elongated clip that serves as a retaining means for retaining the net means in operative relationship with the frame means. In the preferred embodiment, the retaining means is a single elongated clip comprised of two different material substances, each substance having its own rigidity characteristics, in order that the assembled device can provide both the desired rigidity for retaining the net on the frame along with a flexible/soft contact portion for improved cleaning of pool surfaces. Accordingly, for apparatus and methods that are focused on this objective, the portion of the retaining means that grips the frame means is rigid enough to hold the net means on the frame means, and the contact portion of the retaining means is relatively softer, soft enough to desirably conform to variations in pool surfaces and provide reduced abrasion to vinyl liners or similar surfaces during cleaning.

One of the many methods of creating such an improved tool (having a single elongated clip comprised of two different material substances) is by a process called coextrusion. Coextrusion is very similar to ordinary plastic extrusion. However, whereas ordinary extrusion involves forcing a single molten plastic substance through a die, coextrusion actually involves forcing two different molten plastic substances that are heated separately to pass together and adjacently through a single die. As the two substances meet in the die, they bond to each other and are subsequently pulled, stretched, formed and cooled as one single elongated piece. Coextrusion is accomplished with a variety of plastics such as ABS, Polypropylene or Polyethylene, and coextruded parts generally are a single piece of plastic comprised of two different material characteristics (such as rigidity and/or colors, etc.). Although coextrusion is apparently used in many other industries, it does not appear to have been used in connection with pool leaf rakes or similar devices.

Another object of my invention is to provide a tool similar to the aforementioned cleaning tool, in which the profile of the retaining means is generally U-shaped and comprised of two different materials, with each material having its own unique rigidity. Among other things, the less rigid portions of the retaining means are preferably located in distinct areas of the profile to allow additional flexibility in key areas of the retaining means in order to increase ease of assembly, disassembly, and reassembly of the cleaning tool.

An additional object of my invention is to provide tools similar to the aforementioned characters that are comprised of a frame means that forms a mouth portion, a net means covering the mouth portion of the frame means, a single retaining means made with two different material substances, each substance having its own unique rigidity, and the retaining means being available in a variety of configurations that have unique features which contribute to the effectiveness of the cleaning tool.

Yet another object of my invention is the provision of an improved tool for cleaning debris from swimming pools, including the combination of a frame means forming a mouth portion, a net means covering the mouth portion, and a retaining means that both holds the net on the frame and provides contact areas that contribute to the effectiveness of the cleaning tool. The component of the frame that forms the frame's mouth portion has a cross-sectional profile that may include angles, notches and/or corners. Preferably, interior surfaces of the elongated retaining clip interlockingly fit with the frame's angles, notches and corners to increase the clip's effectiveness in retaining the net on the frame. While some of the features that comprise the clip's interlocking surfaces may be made from a rigid material, other parts of the interlocking surfaces may be made from a second, more flexible material so that assembly, disassembly, and reassembly of interlocking components is easier. Such flexible material can provide other benefits, such as improving the effective “grip” of the retaining means holding the net in position on the frame member.

Still another object of my invention is to provide an improved tool for cleaning debris from swimming pools, including the combination of a frame means forming a mouth portion and a net means covering the mouth portion, with an elongated clip that serves as a retaining means for retaining the net means in operative relationship with the frame means. The retaining means is a single elongated clip comprised of at least two distinct portions made from different material substances, each substance having its own unique rigidity. There is a gripping portion that retains the net on the frame, and a contact portion that makes contact with a pool's surface and has features that contribute to the effectiveness of the cleaning tool. In an alternative embodiment, the two or more portions are formed separately and then interlocked with each other, or snapped together, glued, bonded, or otherwise affixed to one another to form a single, elongated clip. Still other embodiments can include one material layer covering all or most of another layer (for example, a stiff inner clip can be “coated” with a softer exterior layer, or a softer cover element snapped over or onto a supporting/gripping clip). In certain applications, it can even be desirable to reverse the relatively hard/soft materials (soft inside, hard outside) and/or to have discrete and differently performing sections or portions of a “single” contiguous layer enwrapping the tool's frame.

A further object of my invention is to provide tools similar to the aforementioned characters that are comprised of a frame means that forms a mouth portion, a net means covering that mouth portion, a single retaining means made with two different material substances, each substance having its own unique rigidity and corresponding gripping or cleaning function, and one or more additional portions formed separately and attached to the single retaining means. In an alternative embodiment, the one or more additional portions are glued, bonded, interlocked, snapped together or otherwise affixed to the single, elongated clip.

An additional object of my invention is to provide tools similar to the aforementioned characters that are comprised of a frame means that forms a mouth portion, a net means covering the mouth portion of the frame means, a single retaining means made with two different material substances, each substance having its own unique rigidity. Preferably, the retaining means is available in a variety of configurations that have unique features which help retain the net on the frame and contribute to the effectiveness of the cleaning tool. For aesthetic or other purposes, each different material substance of the clip element or retaining means can have its own distinct color. In instances where the material substances also have different rigidity and flexibility, the different colors can serve to identify those areas of rigidity and flexibility.

Still another object of my invention is the provision of a retaining means to be used on a cleaning tool that is coextruded or otherwise formed from more than two different materials simultaneously. Among other things, such assemblies may provide an even more precise control of the materials within the tool, such as having three or more material stiffnesses, weights, colors, etc.

Other objects and advantages of the invention will be apparent from the following specification and the accompanying drawings, which are for the purpose of illustration only.

### BRIEF DESCRIPTION OF THE DRAWINGS

FIG. 1 is a perspective view of a preferred embodiment of the elongated retaining means made in accordance with the teachings of the invention, prior to assembly with a frame and/or other elements;

FIG. 1a is a profile view of FIG. 1;

FIGS. 2a, 2b, 2c, 2d, 2e, 2f, 2g, 2h, 2i, and 2k are profile views similar to FIG. 1a, illustrating some of the many other alternative embodiments of the retaining means of FIG. 1;

FIG. 2j is a profile view similar to FIG. 2e, showing yet another embodiment of the invention, with the retaining means cooperatively assembled with a frame member, and the retaining means contacting the interior surface of a swimming pool or other water feature;

FIGS. 3a and 3b are cross-sectional profile views similar to FIGS. 1a and 2a, showing the retaining means assembled around a portion of a frame means that preferably helps form an opening to receive debris during use of the invention;

FIG. 3c is a profile view similar to FIGS. 3a and 3b, but illustrates another of the many alternative embodiments of the invention as it might be used on a non-rectangular or rounded rod frame member or frame portion;

FIG. 4 is a sectional view along line 35 of FIG. 9, illustrating the invention assembled with a frame means and retaining the edge of a net element with respect to the frame;

FIGS. 5a and 5b are profile views similar to FIGS. 3a and 4 (respectively), illustrating the embodiment making contact with the interior surface of a pool or other water feature, and further illustrating the sometimes desirable deformation of the contact edge that may occur upon the application of sufficient force by a user;

FIG. 6 is a foreshortened perspective/sectional profile view along line 35 of FIG. 9, showing the embodiment making contact with the interior surface of a pool or water feature, said surface having a variation in texture or other non-planar and/or non-smooth irregularity (such as a pebble or other debris);

FIG. 7 is a profile view of another embodiment of the elongated retaining means of the invention adjacent a frame member or element, illustrating one of the many methods of assembly and disassembly with that frame member/means;

FIGS. 8a, 8b, and 8c are profile views of still further alternative embodiments of the invention;

FIG. 8d is a profile view of yet another alternative embodiment of my invention, illustrating the contact portion or edge of the retaining means as being formed from relatively more rigid material and the generally U-shaped or gripping portion of the retaining means as being formed from relatively more flexible material;

FIG. 9 is a plan view of a further embodiment of the invention, illustrating a retaining strip assembled with a frame means so that it helps hold a net means in a desired position with respect to the frame;

FIG. 10a is a profile view of a retaining means having a rigid U-shaped gripping portion within a flexible outer portion;

FIG. 10b is a profile view showing the two rigid legs of a retaining means' U-shaped gripping portion joined by a flexible contact portion;

FIG. 10c is a profile view of an alternative embodiment of a retaining means, wherein the U-shaped gripping portion has adjacent contact portions partially surrounding said gripping portion;

FIG. 10d is a profile view of a retaining means made up of an outer, contact portion formed from rigid plastic, and an inner, gripping portion made from plastic that is more flexible than the outer portion;

FIG. 10e is a profile view of retaining means that has a rigid U-shaped gripping portion to grip a net on a frame, and an adjacent flexible contact portion with teeth-like ridges that enhance scrubbing or cleaning

### DETAILED DESCRIPTION

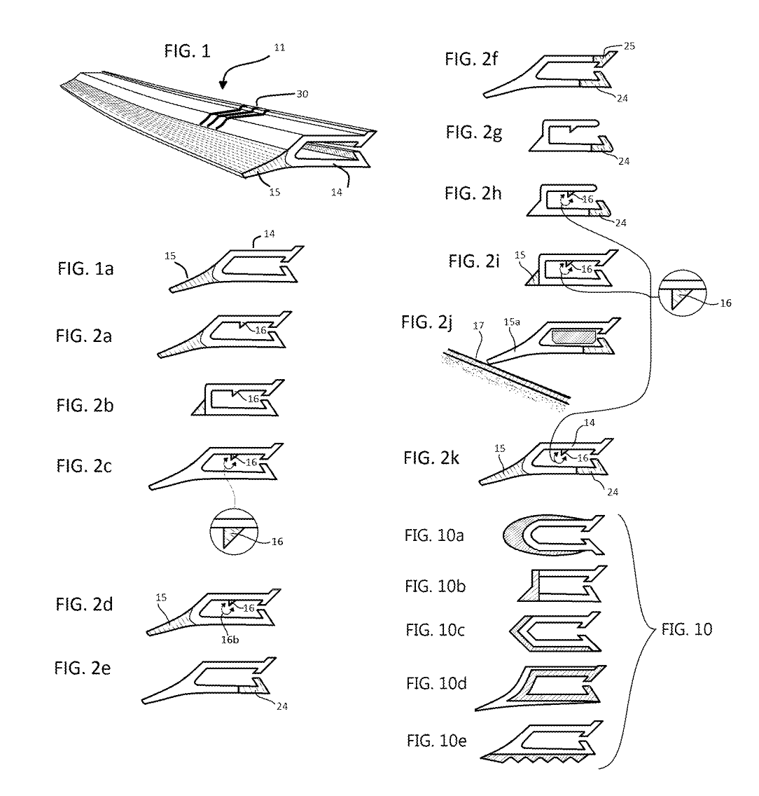

Referring now to the drawings, and particularly to FIGS. 1, 5a, 5b and 9, a preferred embodiment of a swimming pool cleaning tool 10 is shown including a preferred embodiment of an elongated retaining clip 11 holding a preferred net means 12 on a frame means 13, the net means preferably having anti-slip devices 33 to prevent its edges from slipping between the frame means and the retaining means. Preferably, the retaining means 11 is formed from two different material substances being simultaneously formed into a single piece. In the retaining means, one substance is preferably more rigid than the other. In a preferred embodiment, slots 30 can be cut into designated portions of the retaining means in order to help it conform to the shape of the mouth portion of the frame means. In a preferred embodiment, the two substances are coextruded plastics forming one single elongated retaining means. Preferably, the U-shaped portion 14 of the coextruded retaining means is made of a plastic material that is rigid enough to grip the frame 13 tightly and hold the net 12 onto said frame during normal use of the cleaning tool. The contact portion 15 of the retaining means that makes contact with the interior surface 17 of a pool during cleaning is preferably more flexible than the U-shaped portion 14 that retains the net on the frame. Persons of ordinary skill in the art will understand, however, that it may be advantageous to have a flexible U-shaped portion and rigid contact portion, and/or portions of each part that are rigid and/or flexible in order to accommodate a variety of surfaces to be cleaned and/or different sized and shaped frame means. Furthermore, persons of ordinary skill in the art will understand that the coextruded (multiple material) features of my current invention can easily be adapted and used to provide virtually any existing shape of pool leaf rake retaining means, as well as many or all future shapes.

A flexible contact portion provides many advantages when compared to a rigid contact portion. Among the many benefits, a flexible contact portion 15 provides a smoother cleaning action over surfaces that may benefit from reduced abrasion. This is accomplished by way of the flexible contact portion bending, flexing and conforming to the shape/surface/texture of the surface to be cleaned. Therefore, when a flexible contact portion encounters an irregularity in the surface, it is able to conform to the shape of the irregularity without damaging the surface to be cleaned or the contact portion. For example, as shown in FIGS. 5a and 5b, the flexible contact portion 15 of a coextruded retaining means flexes as it makes contact with a pool surface 17. FIG. 6 shows how this flexing action is particularly helpful in reducing abrasion when the cleaning tool of the present invention is used in a vinyl pool that has small rocks or debris 18 caught between the vinyl liner 17 and the hard ground or other firm surface 19 upon which the vinyl liner lays. In such cases, the flexible contact portion 15 can conform to the variations in the vinyl's surface 20, allowing smoother cleaning action and reduced abrasion on the vinyl liner. These features benefit smooth pool surfaces with slip reducing textures in a similar way.

As mentioned above, a variety of shapes of elongated retaining means can be useful on pool leaf rakes and may depend upon, among other things, consumer preferences. Whereas some are designed to actually scoop under targeted debris during cleaning and have a smooth, ramping transition surface that urges the targeted debris into the net in a manner consistent with my U.S. Pat. No. 5,473,786, others have more blunt contact portions and do relatively little lifting of debris. As also mentioned above, the coextruded features of my current invention can easily be adapted and used on all such designs. FIGS. 1a and 9 illustrate a retaining means that has a U-shaped portion 14 for gripping and retaining a net on a frame, said U-shaped portion being made from a rigid plastic. Coextruded with this rigid U-shaped portion is a flexible contact portion 15 designed to lift debris with a smooth transition surface and direct the debris through the mouth portion 21 of a cleaning tool's frame 13 and into the tool's net portion 12.

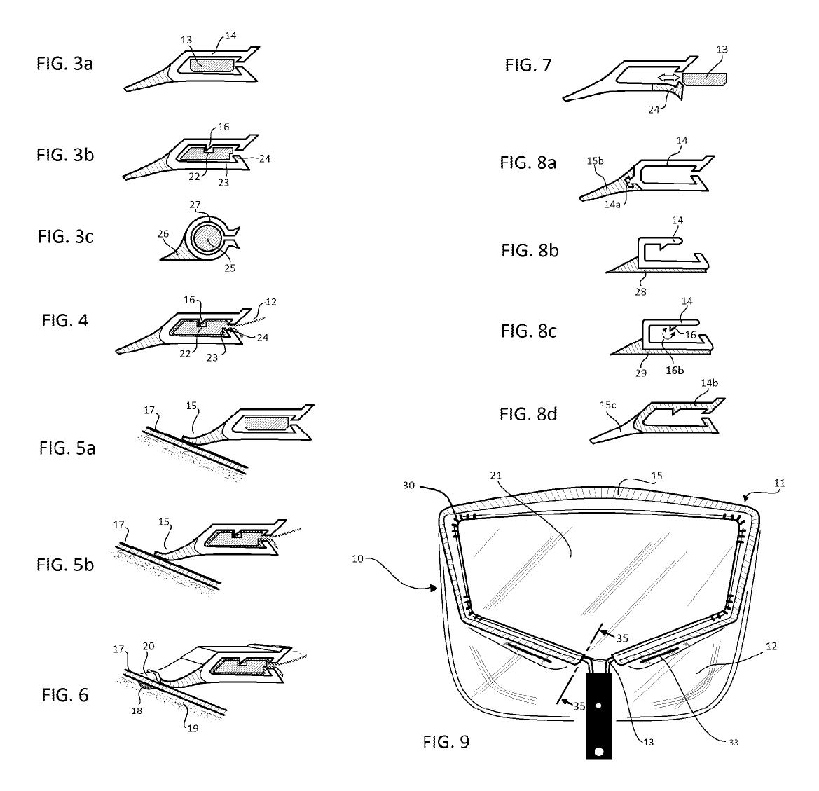

Some manufacturers and consumers prefer modular designs that use retaining means that require the least amount of effort during assembly, disassembly, or reassembly on a frame element. Although the invention can be practiced in many other embodiments that do not focus on this element or feature, FIG. 3a illustrates how a U-shaped portion 14 of the retaining means preferably can be easily snapped around a frame 13.

Other manufacturers and consumers prefer modular retaining means that are somewhat more complicated (but arguably provide a more secure assembly or some other perceived benefit). Among other approaches, these can have cooperating/interlocking elements on the retaining means and/or the frame, such as one or more angles, notches, and/or corners. Examples of some of the many such profiles are shown in FIGS. 2a and 2b, illustrating the addition of an interior tooth or detent 16. As shown in FIGS. 3b, and 4, this tooth preferably interlocks with a corresponding groove 22 that can be provided along the length of some or all of the frame element (such as the part that forms the mouth portion). Among other things, such interfitting elements can provide added extra friction to the assembled parts, to even better ensure that net portion 12 will not slip off of or become disengaged from the tool.

Persons of ordinary skill in the art will understand that the size, shape, location, orientation, and/or number of such cooperating elements can be modified depending on the application and a number of factors. For example, one or more additional shapes (such as notch 23 at the corner of the frame (see FIG. 4)) can provide a rear “locking” location to help retain the net in its desired relationship in the assembly. Although the drawings generally illustrate female engagement elements on the frame members and corresponding male engagement elements on the retaining means, persons of ordinary skill in the art will understand that the male/female orientations can be reversed, that any such “female” element on the retaining means might be formed from a material different from other parts of the retaining member, and that (in certain applications) the frame itself might be formed from multiple different plastic or other materials so that (for example) a male portion or element of the frame might have different color or material characteristics than other parts of the frame.

While interlocking features may help prevent the net portion from slipping off the frame, they correspondingly make assembly, disassembly and reassembly of the swimming pool cleaning tool more difficult. In certain embodiments of the present invention, however, various portions of the retaining means can be formed from different materials, each having its own material properties (such as flexibility, etc.). For example, by using a coextruding process or other suitable method of manufacture, some or all of those interlocking features of the retaining means can be formed from a relatively more flexible material, which can make assembly, disassembly, and reassembly of parts easier while still providing a sufficient or desirable level of increased “gripping” and retention of the net. Thus, in the example of FIG. 2c, the entire profile of the retaining means is formed with rigid plastic except that the interior tooth 16 is formed with a more flexible plastic or similar material. In this embodiment, the flexible tooth can more easily bend during assembly, disassembly and reassembly (as compared to embodiments in which the tooth is formed from the same stiffer material as the rest of the retaining means), while still adding a desired amount of friction to help retain the net on the frame when the entire cleaning tool is assembled and/or in use.

Persons of ordinary skill in the art will understand that, although many of the drawings illustrate the use of two different materials within the retaining means element and show those materials as being in single contiguous portions of the retaining means, the invention can be practiced in a wide variety of other ways, including for example using more than two such different materials, and/or using the same material at two or more different, non-contiguous locations within the cross-section of the retaining member. As previously discussed, such embodiments can provide benefits such as easing the assembly, disassembly, and reassembly of the retaining member onto a frame element. For example, FIG. 2e shows one of the preferred embodiments wherein the entire profile of a retaining means is formed from relatively rigid plastic (or other suitable material) while a rear interlocking portion 24 is formed from relatively more flexible plastic (or other suitable material). FIG. 2j illustrates another embodiment wherein the more rigid contact portion 15a of FIG. 2e has little or no flex or deformation when pressed against a pool's surface. FIG. 7 shows how the flexibility of the rear portion 24 will enable the frame 13 to pass in and out of the retaining means more easily during assembly and reassembly. FIG. 2g is similar to FIG. 2e, but demonstrates how a flexible rear portion 24 may be coextruded on a retaining means that is blunt with little ability to lift debris and/or designed to fit interlockingly with a frame. FIG. 2f is similar to FIG. 2e but has an additional side of the U-shaped portion formed with flexible material for the purpose of creating even greater ease of assembly, disassembly, and reassembly of the cleaning tool. As indicated above, persons of ordinary skill in the art will appreciate that the possibilities for interlocking assemblies/configurations are limitless, and not limited to those examples discussed herein.

Some manufacturers and consumers use pool leaf rake frames that employ a frame with some cross section other than a rectangle (for example, a rod). FIG. 3c shows how a retaining means that fits the circular profile of a rod 25 can have a coextruded portion 26 formed adjacent to a rigid portion 27 that holds a net in place on the frame means.

There are further instances where multiple coextruded features may be useful and/or desired. For example, FIG. 2h illustrates how the use of a flexible interlocking tooth 16 can be combined with a flexible rear portion 24 of the U-shaped portion of the retaining means, thus allowing an interlocking frame to be even more easily assembled, disassembled, and reassembled than the profile shown in FIG. 2g. And while FIGS. 2d and 2i illustrate configurations having both a flexible tooth 16 and a flexible contact portion 15, further advantages are provided in configurations such as illustrated in FIG. 2k, which shows a rigid U-shaped portion 14 that grips a frame combined with a flexible contact portion 15, a flexible tooth 16, and a flexible rear portion 24, all culminating in an interlocking retaining means that provides reduced abrasion at contact with even potentially greater ease of assembly, disassembly, and reassembly of parts.

Persons of ordinary skill in the art will understand that while coextrusion is the preferred method of creating a single retaining means from more than two different materials simultaneously, it is possible to provide a retaining means which is formed from separate parts that are keyed to each other or otherwise fitted together. For example, in FIG. 8a, the U-shaped portion 14 of the retaining means preferably is formed as a single, separate part, and has attachment means or key 14a formed adjacent to the area where the retaining means normally will make contact with a pool's surface during use. A separate and attachable contact portion 15b, also preferably formed as a single, separate part, has one or more keyed or mating features in its design, that allow it to be fitted and/or otherwise affixed, through a snapping feature, glue, or any other bonding means, to the keyed/attachment means 14a of said U-shaped portion 14. In certain embodiments, the separate and attachable contact portion 15b may be removable and replaceable.

Persons of ordinary skill in the art will appreciate that the invention can be practiced using any suitable materials and methods of manufacture and assembly. For example, there are many possible variations in which a single retaining means can be made from two or more parts of different materials. FIG. 8b represents merely one of many options in which the U-shaped portion made from one material can have bonded to it a secondary portion 28 formed of a different material. Further options include bonding or attaching a secondary or even tertiary part to an already coextruded retaining means. FIG. 8c shows the profile of a single retaining means having a rigid U-shaped portion 14 that is coextruded with a flexible interlocking tooth 16, said single retaining means having an additional part 29 bonded or attached to it. FIG. 8d shows yet another embodiment of a single coextruded retaining means that has a flexible U-shaped portion 14b and a rigid contact surface 15c. The two portions 14b and 15c in FIG. 8d can also be made separately and bonded or attached to each other through some means other than coextrusion.

Furthermore, in one embodiment, a method of cleaning an object such as the surface of a pool or the like is provided. The method may include some or all of the steps of: 1) identifying objects to be cleaned from the pool (i.e. leaves, twigs, or other debris) since debris may be floating on the pool's surface, suspended in the water, or laying on the bottom surfaces (pool bottom, steps, seats, etc.); 2) cleaning surface debris by a) trapping it against the pool's surface with the mouth portion of the tool, b) skimming the surface with the tool in such a way that part of the frame's mouth is submerged in the water while a remaining portion of the frame's mouth is above the surface, or c) approaching the debris with the tool below the water's surface and scooping the debris while lifting the tool out of the water; 3) cleaning suspended debris by moving the tool towards in such a way that the debris gets caught in the tool's mouth portion and is forced into the net; and 4) cleaning debris from the pool's bottom surfaces by a) laying the tool on the bottom surface in such a way that the contact portion of the retaining means is pointed at targeted debris, b) pushing the tool along the bottom until the contact portion of the retaining means raises the debris from the bottom, and c) continue pushing the tool until the debris is caught in the net portion of the tool.

In an alternative embodiment, a method of cleaning may include providing a cleaning tool such as the one described herein. Preferably, the contact portion of the cleaning tool makes sufficient contact with the surface of the object to be cleaned, such that the tool can easily slide along the surface and catch debris which is removed from the surface by the contact portion. Persons of ordinary skill in the art will understand that a wide range of methods associated with the present invention are possible, including but not limited to methods of manufacturing and methods of assembling a cleaning tool such as the one described herein.

In another embodiment, a method of assembling the device described herein is provided. This method may include some or all of the steps of: 1) providing a frame, a net and a retaining means; 2) holding the frame in such a way that the net can be placed over the frame's mouth portion; 3) holding the net in place with the frame to prepare it for assembly with the frame; 4) folding the edges of the nets mouth over the frame's mouth; 5) affixing the net's anti-slip means (i.e. Velcro) into proper position, with the edges of the net positioned to wrap around the mouth portion of the frame; 6) while holding the net on the frame, snap the retaining means over the frame so that the edges of the net will wrap around the frame as the frame passes into the gripping portion of the retaining means; 7) continue this process around the frame until the entire retaining means is snapped onto the frame and is holding the entire mouth portion of the net around the entire mouth portion of the frame (save the small areas adjacent to the tubular attachment means that ultimately lay between the ends of the mounted retaining means); and 8) ensure that the retaining means is completely snapped onto the frame and any interlocking portions of the retaining means and the frame are seated properly.

In yet another embodiment, a method of disassembling the device described herein is provided in order to allow for replacement of parts. The method may include some or all of the steps of: 1) gripping the rear ends of the U-shaped portion of the retaining means in a way that spreads the legs of the U-shaped portion apart; 2) releasing anti-slip means on the net (if any, and if net removal is desired); 3) pulling the retaining means away from the frame and, where necessary, continue to spread areas of the U-shaped portion of the retaining means that do not readily disengage from the frame; and 4) removing and replacing the net if desired.

In still another embodiment, a method of manufacturing the device described herein is provided. The method may include some or all of the steps of: 1) determining which materials of differing properties are compatible with each other for coextrusion and suitable for a retaining means that must grip a net on a frame and make contact with a pool's surface during cleaning; and 2) mixing, loading, heating, and extruding the designated differing materials together through a die in a manner consistent with coextrusion so that the designated differing materials form a retaining means having a profile composed of a) a U-shaped portion for gripping a net on the frame of a tool for cleaning swimming pools, and b) a contact portion for making contact with a pool's surface when mounted on a tool used to clean swimming pools.

A preferred method of manufacturing the retaining means with a U-shaped portion and contact portion of different material substances includes coextrusion. Persons of ordinary skill in the art will appreciate, however, that the U-shaped portion and contact portion may be joined together by some other process such as bonding with glue or a similar adhesive substance, or the formation of two extrusions (such as tabs) that snap/lock together.

As indicated above, the shape and size and materials used for the various components of the invention can vary widely, depending on the specific application for which the invention may be intended and other factors (costs, weight, etc.). For example, FIGS. 10a-10e illustrate some of the many alternative embodiments of the retaining means of the invention having varying sized and shaped contact portions and U-shaped portions. For certain applications (for example spas), the shape and/or size of the frame and/or assembly may need to be relatively smaller and lighter than embodiments used on swimming pools. Likewise, such applications may use frame elements that are NOT removable from relatively shorter handles or poles (as compared to conventional removable, telescoping poles used when cleaning swimming pools).

Persons of ordinary skill in the art will understand that various method steps to assemble these and other alternative embodiments, and the method steps by which the invention may be used in such applications, may vary somewhat but still be within the scope of the invention. Among other things, once the cleaning apparatus has been assembled (or if it is already assembled and/or non-modular), the tool preferably can be used in a number of ways, including many that are useful for cleaning pools, spas, or other things. Various parts of the apparatus (such as the roughened/serrated surface(s) of the tool, etc.) can be manipulated by a user to scrape or loosen debris. The contact edge can function, among other things, as a “squeegee” when cleaning a surface (although the surface may in fact be underwater).

The apparatus and methods of my invention have been described with some particularity, but the specific designs, configurations, and steps disclosed are not to be taken as delimiting of the invention in that various modifications will at once make themselves apparent to those of ordinary skill in the art, all of which will not depart from the essence of the invention, and all such changes and modifications are intended to be encompassed within the appended claims.

1. In a tool for cleaning debris from swimming pools, the combination of a frame means forming a mouth portion, said tool including a net means covering said mouth portion and a retaining means to retain said net means on mouth portion of said frame means, said retaining means being a single and separate device having one gripping portion that grips said frame and holds said net on said frame, and another contact portion designed to make contact with a pool's surface for the purposes of cleaning, said gripping and contact portions being made from two different material substances.

2. The tool of claim 1, in which the two different material substances comprise a single retaining device.

3. The tool of claim 1 or claim 2, in which the two different material substances differ in the degree of their respective rigidity or flexibility.

4. The tool of claim 1 or claim 2 or claim 3, in which the two different material substances differ in the colors of said substances.

5. The tool of claim 1 or claim 2 or claim 3 or claim 4, in which the gripping portion of the retaining means is fabricated from a relatively more rigid material substance, and said contact portion is fabricated from a material substance that is relatively more flexible than the relatively more rigid material substance of said gripping portion.

6. The tool of claim 1 or claim 2 or claim 3 or claim 4, in which the contact portion is fabricated from a relatively more rigid material substance, and said gripping portion of the retaining means is fabricated from a material substance that is relatively more flexible than the relatively rigid material substance of the contact portion.

7. The tool of claim 1 or claim 2 or claim 3 or claim 4 or claim 5 or claim 6, in which said mouth portion of said frame means includes at least one female engagement surface such as a notch, corner or angle, and said gripping portion of said retaining means includes at least one male engagement surface such as a protrusion, angle, or other feature that matingly engages with said female engagement surface of said mouth portion of the frame means in order to secure the frame means in the retaining means.

8. The tool of claim 1 or claim 2 or claim 3 or claim 4 or claim 6 or claim 7, in which the gripping portion of the retaining means is made from a rigid material, and said gripping portion has select areas made from a material substance that is more flexible than the rigid material substance of said gripping portion.

9. The tool of claim 1, in which said retaining means is formed by at least two separate parts joined together.

10. The tool of claim 1 and claim 9, in which one or more of the separate parts that comprise said retaining means are removable and replaceable in relation to each other.

11. The tool of claim 1 or claim 2 or claim 3 or claim 4 or claim 5 or claim 6 or claim 7 or claim 8 or claim 9 or claim 10, in which said retaining means is formed by at least two separate components which are glued, bonded or otherwise affixed to each other.

12. A retaining means for retaining a net on a frame of a pool cleaning apparatus, in which the frame has a central opening forming a mouth portion that is covered by a net, said retaining means having an elongated body having a substantially U-shaped cross-section, said cross-section being formed from a material having a preferred degree of rigidity and forming a portion that grips said frame to retain said net on said frame, said retaining means also having a second portion which makes contact with a pool's surface during cleaning, said second portion being formed from a material which is different from the material of the U-shaped cross-section and having a different preferred degree of rigidity from said U-shaped cross-section.

13. The retaining means of claim 12, in which the material of said substantially U-shaped portion is more flexible than the material of said contact portion.

14. The retaining means of claim 12, in which the material of said substantially U-shaped portion is more rigid than the material of said contact portion.

15. A retaining means for retaining a net on a frame of a tool for cleaning debris from swimming pools, in which the frame has a central opening covered by a net, said retaining means having an elongated body having a substantially U-shaped cross-section, said U-shaped cross-section designed to grip said frame and retain said net on said frame, said U-shaped cross-section being adjacent to portions of the retaining means configured to contact a pool's surface during cleaning, said U-shaped section and contact portions being made from a material substance that has a desired degree of rigidness, said U-shaped section further having designated areas within it made from a material substance that is more flexible than said rigid substance used in the overall U-shaped portion and contact portion, said flexible portions provided for the purpose of easing assembly, disassembly, and reassembly.

16. The retaining means of claim 12 or claim 13 or claim 14, in which the profile of the component of the frame means that forms the mouth portion of the cleaning tool has notches, corners or angles, and said retaining means having corresponding protrusions, angles, or other features that interlock with said notches, corners or angles of said component of the frame means.

17. The retaining means of claim 15, in which the frame has notches, corners or angles, and the retaining means has corresponding protrusions, angles, or other features that interlock with said notches, corners or angles of said frame.

18. A tool for cleaning debris on an object, comprising: frame means forming a mouth portion, net means covering said mouth portion, and retaining means for retaining said net means in an operative relationship with said frame means; said retaining means having a gripping portion for gripping said frame and retaining said net means on said mouth portion of said frame means, and a contact portion configured to contact a surface portion of the object for cleaning; wherein said gripping and contact portions are fabricated from two different material substances.

19. Apparatus for cleaning debris from a body of water or similar liquid in which said body is defined by at least one generally solid surface, the apparatus including at least the following elements:
a frame element,
a screen element,
a clip element to hold the screen and frame elements in a desired relationship with each other and permit the debris to be trapped in the screen when the assembled elements are passed through the body of water or similar liquid, and
a contact lip associated and cooperating with the clip element, said contact lip configured and positioned with respect to the other assembled elements so that it may at least substantially contact the generally solid surface when the assembled elements are passed through the body of water or similar liquid,
in which the clip element and/or the contact lip are fabricated from at least two different materials.

20. A method of cleaning debris from a body of water or similar liquid in which said body is defined by at least one generally solid surface, including the steps of:
providing the apparatus of claim 19;
positioning the apparatus such that said contact lip makes contact with the generally solid surface;
passing the apparatus through the body of water along the generally solid surface in order to trap debris in the screen.

21. A clip for a pool cleaning net assembly, the clip being fabricated from at least two different materials, each having at least one distinct material property.

22. The clip of claim 21, in which the materials have the distinct material property of being different colors.

23. The clip of claim 21 or claim 22, in which the materials have the distinct material property of having different flexibility characteristics.

24. The clip of claim 21, in which the materials have the distinct material property of having different surface hardnesses.

25. The tool of claim 1 or claim 2 or claim 3 or claim 4 or claim 5 or claim 6, further including at least one pair of cooperating elements associated respectively with said frame means and said retaining means, said cooperating elements sized and configured to matingly engage with each other upon assembly of said frame means and said retaining means.
